(19) United States
(12) Patent Application Publication
(10) Pub. No.: US 2015/0358504 A1
(43) Pub. Date: Dec. 10, 2015

(54) SYSTEM AND METHOD FOR VECTOR ERROR DIFFUSION

(71) Applicant: QUALCOMM MEMS Technologies, Inc., San Diego, CA (US)

(72) Inventors: Songhe Cai, San Diego, CA (US); Shen-ge Wang, Milpitas, CA (US)

(21) Appl. No.: 14/296,252

(22) Filed: Jun. 4, 2014

(51) Int. Cl. H04N 1/405; H04N 1/52

(52) U.S. Cl. CPC H04N 1/4052; H04N 1/52

(57) ABSTRACT

The systems and methods described herein may be used to optimize vector error diffusion for displaying color images on a display device. Vector error diffusion passes a residual vector error from one pixel on to its neighboring pixels with varying weights. The direction and weight of error diffusion can be defined by a vector error diffusion filter. Using a vector error diffusion filter with a limited number of taps allows an a priori determination of which pixel vector is dependent on which pixel vector error at what times. Based on such dependency determination, vector error diffusion calculation for multiple pixels can be scheduled to optimize computation time while preserving the dependency. The scheduled vector error diffusion calculation can further be implemented in virtual pipeline with multiple stages to balance computation load and utilize hardware resource efficiently.

### BACKGROUND OF THE INVENTION

1. Field of the Invention

This disclosure relates to methods and systems for displaying an input image on a display device using vector error diffusion.

2. Description of the Related Art

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Some display devices, such as EMS based display devices, can produce an input color by utilizing more than three primary colors. Each of the primary colors can have reflectance or transmittance characteristics that are independent of each other. Such devices can be referred to as multi-primary display devices. In multi-primary display devices there may be more than one combination of the multiple primary colors to produce the same color having input color values, such as red (R), green (G), and blue (B) values.

Vector error diffusion is often used in color image dithering process to preserve the original color image quality. Vector error diffusion process may use a dithering algorithm that propagates residual vector quantization error of a pixel to its neighboring pixels based on a predetermined weight (coefficient) given for each propagation. Due to heavy computations necessary to determine a vector quantization error of a pixel, large amount of data for high resolution displays, and fast input frame rates, current systems for vector error diffusion often use a dual- or multi-port random access memory (RAM) and an extra internal phase lock loop (PLL) and consume much power.

### SUMMARY

The technique of this disclosure may be generally related to using a pipeline to implement vector error diffusion for display devices.

In one implementation, a method of diffusing vector error comprises in a first time interval, determining a first pixel accumulated vector error by loading a plurality of previously stored diffused pixel quantization vector errors, determining a first pixel pre-quantization vector by adding the first pixel accumulated vector error to a first pixel input vector, and determining a plurality of first pixel quantization differences between the first pixel pre-quantization vector and a plurality of reference vectors. The method further comprises in a second time interval, determining a plurality of first pixel quantization distances based on the first pixel quantization differences, determining a second pixel accumulated vector error by loading another plurality of previously stored diffused pixel quantization vector errors, determining a second pixel pre-quantization vector by adding the second pixel accumulated vector error to a second pixel input vector, and determining a plurality of second pixel quantization differences between the second pixel pre-quantization vector and the plurality of reference vectors. The method further comprises in a third time interval, determining a first pixel quantization vector error based on one of the plurality of first pixel quantization distances, and determining a plurality of second pixel quantization distances based on the second pixel quantization differences. The method further comprising in a fourth time interval, applying an error diffusion filter to one or more pixel quantization vector errors, including the first pixel quantization vector error, to generate and store a diffused first pixel quantization vector error, and determining a second pixel quantization vector error based on one of the plurality of second pixel quantization distances.

In another implementation, a method of diffusing vector error by processing error data of each of a plurality of pixels comprises determining an accumulated vector error based on a plurality of stored diffused quantization vector errors, determining a pre-quantization vector by adding the accumulated vector error to an input vector, determining a plurality of quantization differences based on the pre-quantization vector and a plurality of reference vectors, determining a plurality of quantization distances based on the plurality of quantization differences, determining a quantization vector error based on one of the plurality of quantization distances, applying an error diffusion filter at least to the quantization vector error to generate at least another diffused quantization vector error, and storing the another diffused quantization vector error, the processing of the error data of the plurality of pixels being in a virtual pipeline with a plurality of stages.

In another implementation, an apparatus for diffusing vector error comprises a processor configured to process error data of each of a plurality of pixels by determining an accumulated vector error based on a plurality of stored diffused quantization vector errors, determining a pre-quantization vector by adding the accumulated vector error to an input vector, determining a plurality of quantization differences based on the pre-quantization vector and a plurality of reference vectors, determining a plurality of quantization distances based on the plurality of quantization differences, determining a quantization vector error based on one of the plurality of quantization distances, and applying an error diffusion filter at least to the quantization vector error to generate at least another diffused quantization vector error, the processor further configured to process the error data of the plurality of pixels in a virtual pipeline with a plurality of stages; and a memory configured to save the another diffused quantization vector error for at least one of the plurality of pixels.

In another implementation, an apparatus for diffusing vector error by processing error data of each of a plurality of pixels comprises a means for determining an accumulated vector error based on a plurality of stored diffused quantization vector errors, a means for determining a pre-quantization vector by adding the accumulated vector error to an input vector, a means for determining a plurality of quantization differences based on the pre-quantization vector and a plurality of reference vectors, a means for determining a plurality of quantization distances based on the plurality of quantization differences, a means for determining a quantization vector error based on one of the plurality of quantization distances, a means for applying an error diffusion filter at least to the quantization vector error to generate at least another diffused quantization vector error, and a means for storing the another diffused quantization vector error, the apparatus further configured to process the error data of the plurality of pixels in a virtual pipeline with a plurality of stages.

In another implementation, a system for diffusion vector error by processing error data of each of a plurality of pixels comprises a processor configured to determine an accumulated vector error based on a plurality of stored diffused quantization vector errors, determine a pre-quantization vector by adding the accumulated vector error to an input vector, determine a plurality of quantization differences based on the pre-quantization vector and a plurality of reference vectors, determine a plurality of quantization distances based on the plurality of quantization differences, determine a quantization vector error based on one of the plurality of quantization distances, apply an error diffusion filter at least to the quantization vector error to generate at least another diffused quantization vector error, and store the another diffused quantization vector error, the processor further configured to process the error data of the plurality of pixels in a virtual pipeline with a plurality of stages.

In another implementation, a non-transitory computer-readable medium storing instructions that, when executed, causes at least one physical computer processor to perform a method of diffusing vector error by processing error data of each of a plurality of pixels, the method comprising determining an accumulated vector error based on a plurality of stored diffused quantization vector errors, determining a pre-quantization vector by adding the accumulated vector error to an input vector, determining a plurality of quantization differences based on the pre-quantization vector and a plurality of reference vectors, determining a plurality of quantization distances based on the plurality of quantization differences, determining a quantization vector error based on one of the plurality of quantization distances, applying an error diffusion filter at least to the quantization vector error to generate at least another diffused quantization vector error, and storing the another diffused quantization vector error, the processing of the error data of the plurality of pixels being in a virtual pipeline with a plurality of stages.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIG. 1 is an isometric view of two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a table illustrating movable reflective layer position versus applied voltage for an IMOD display element.

FIG. 4 is a table illustrating various states of an IMOD display element when various common and segment voltages are applied.

FIG. 5 is a flow diagram illustrating a manufacturing process for an IMOD display or display element.

FIGS. 6A-6E are cross-sectional illustrations of various stages in a process of making an IMOD display or display element.

FIGS. 7A and 7B are schematic exploded partial perspective views of a portion of an electromechanical systems (EMS) package including an array of EMS elements and a backplate.

FIG. 8 shows a cross-section of an implementation of an analog IMOD (AIMOD).

FIG. 9 is illustrates an example of a color gamut produced by a multi-primary display device and the standard sRGB color gamut.

FIG. 10 is a block diagram illustrating an example implementation of a method of displaying an image on a multi-primary display device.

FIG. 11 is a block diagram illustrating an example implementation of vector error diffusion.

FIG. 12 is a block diagram illustrating another implementation of vector error diffusion.

FIG. 13 illustrates an exemplary error diffusion filter operation in accordance with one implementation.

FIG. 14 illustrates error propagation and grouping and scheduling of pixels for processing in accordance with one implementation.

FIG. 15 is an exemplary multi-stage vector error diffusion pipeline in accordance with one implementation.

FIGS. 16A and 16B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical, or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing), and a variety of EMS devices. The teachings herein also can be used in non-display applications such as, but not limited to: electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to one having ordinary skill in the art.

The systems and methods described herein may be used to optimize vector error diffusion for displaying color images on a display device. Vector error diffusion passes a residual vector error from one pixel on to its neighboring pixels with varying weights. In turn, a quantization vector error for one pixel is based on the sum of weighted residual vector errors from its neighboring pixels. The direction and weight of error diffusion can be defined by a vector error diffusion filter. Using a vector error diffusion filter with a limited number of taps—e.g., the number of neighboring pixels that would receive weighted residual errors from a pixel—allows an a priori determination of which pixel vector is dependent on which pixel vector error at what times. Based on such dependency determination, vector error diffusion calculation for multiple pixels can be scheduled to optimize computation time while preserving the dependency. The scheduled vector error diffusion calculation can further be implemented in a virtual pipeline with multiple stages to balance computation load and utilize hardware resource efficiently.

Systems and methods described herein can be used for rendering static images as well as video (e.g., video with fast moving objects). In various implementations, the display device can include an output buffer to store the indices for the primary colors and/or the last input image. A look-up table (LUT) can be used to store a correspondence between the display color and a set of primary colors. In various implementations, the output buffer can be configured to store the last input image and display the last input image when the display device is operated in the always-on mode.

Particular implementations of the subject matter described in this disclosure can be implemented to realize one or more of the following potential non-limiting advantages. It is possible to accelerate the hardware speed and achieve a high performance gain due to optimization of the vector error diffusion calculation. It is possible to adapt the vector error diffusion process rate to a high input pixel clock frequency to support the requirements of a high resolution display with a fast input frame rate in a display driver design. It is also possible to reduce the number of internal PLL circuits to reduce power consumption and use a single-port RAM as opposed to a dual-port RAM, for example, to reduce the cost of hardware. Furthermore, the flexible architecture disclosed herein is easy to modify according to different design requirements and tradeoffs. For instance, the architecture disclosed herein is scalable.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

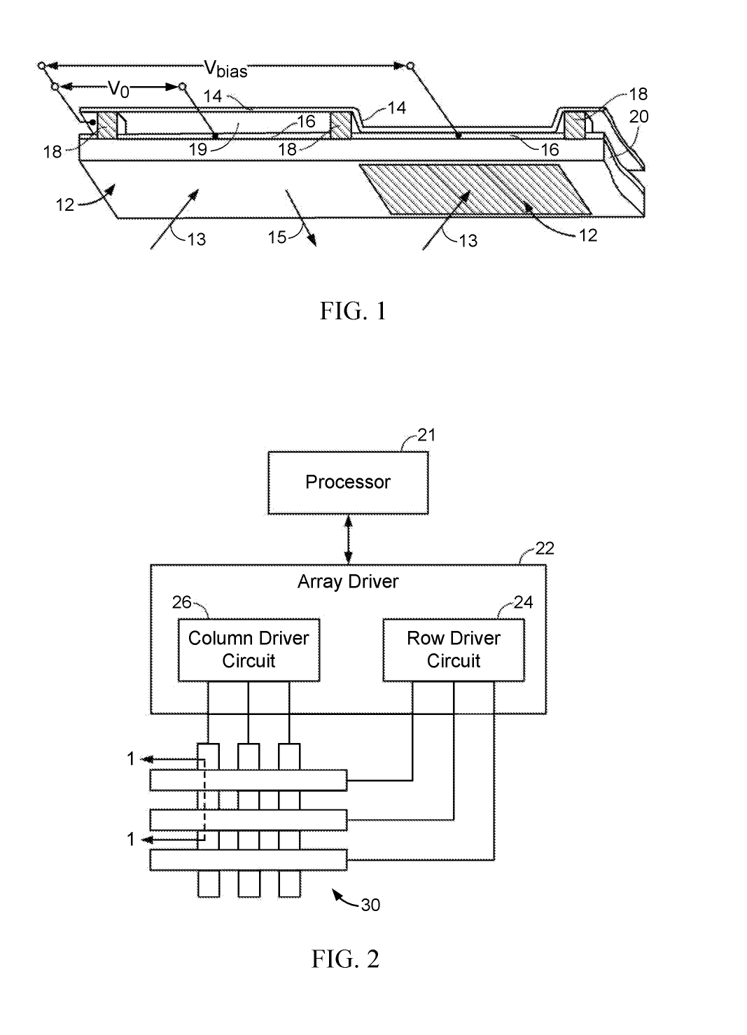

FIG. 1 is an isometric view of two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (e.g., a movable layer, also referred to as a mechanical layer) and a fixed partially reflective layer (e.g., a stationary layer), positioned at a variable and controllable distance from each other to form an air gap (also referred to as an optical gap, cavity or optical resonant cavity). The movable reflective layer may be moved between at least two positions. For example, in a first position, e.g., a relaxed position, the movable reflective layer can be positioned at a distance from the fixed partially reflective layer. In a second position, e.g., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, e.g., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

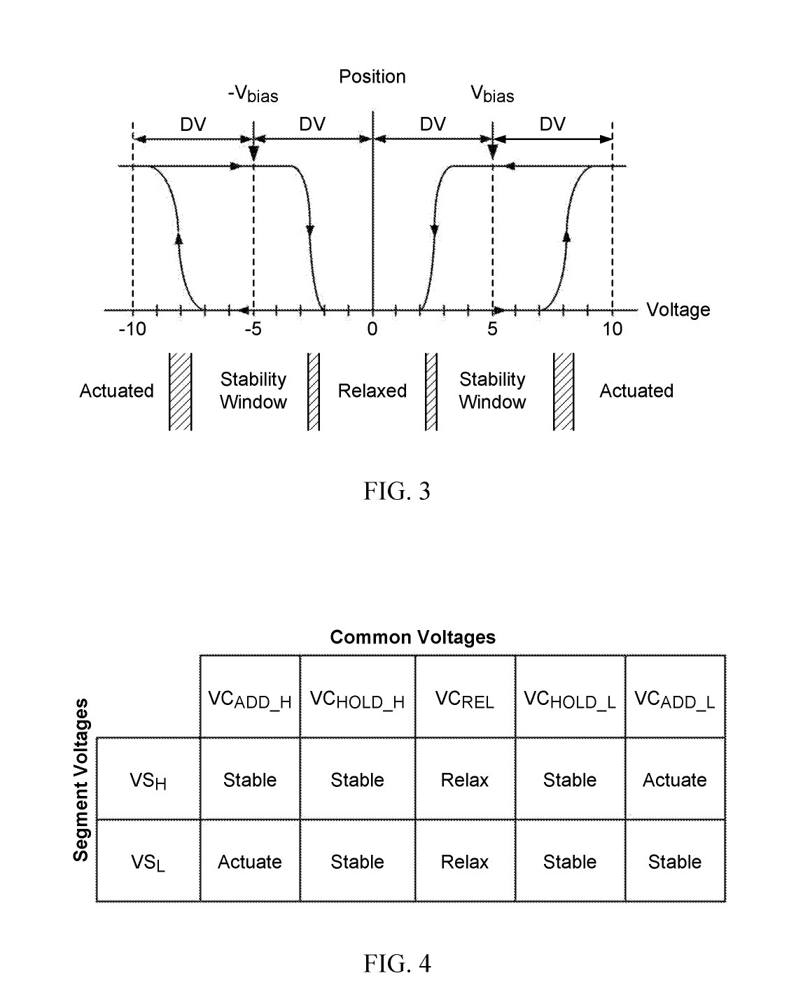

FIG. 3 is a graph illustrating movable reflective layer position versus applied voltage for an IMOD display element. For IMODs, the row/column (for example, common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts; however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously stored, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, e.g., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{DD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{DD}_{_{—}}_{L} is applied, with high segment voltage VS_{H} causing actuation of the modulator, and low segment voltage VS_{L} having substantially no effect (for example, remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

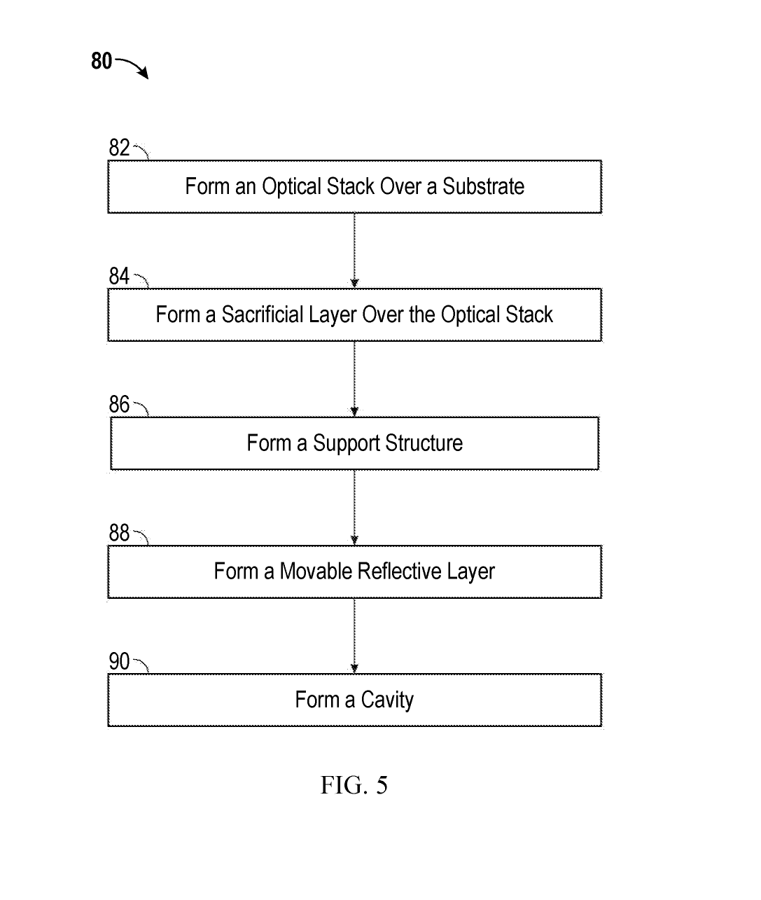

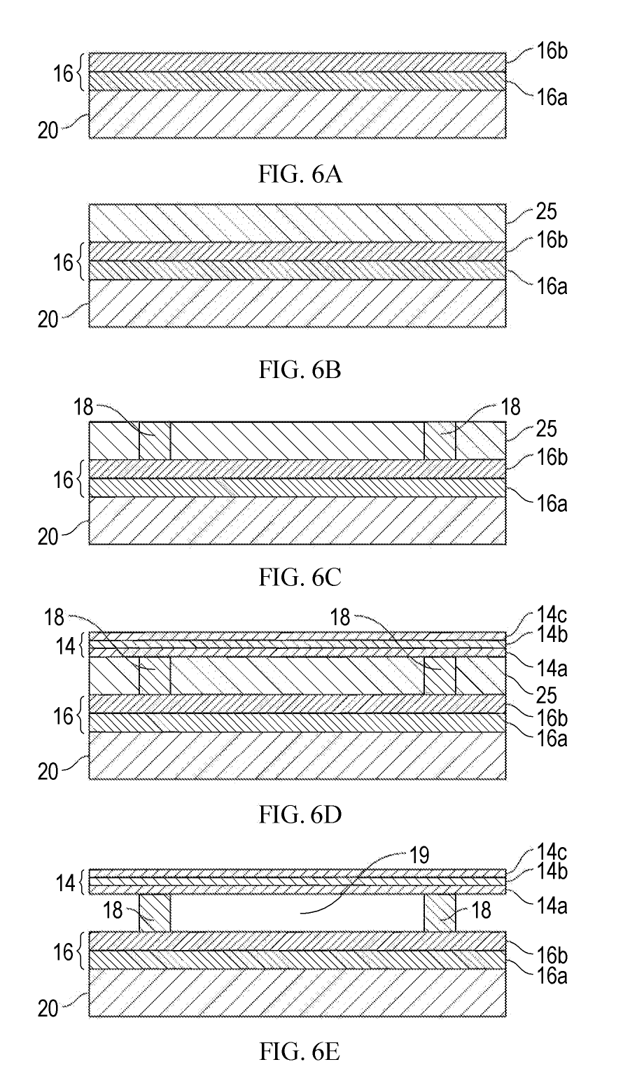

FIG. 5 is a flow diagram illustrating a manufacturing process 80 for an IMOD display or display element. FIGS. 6A-6E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 5. The process 80 begins at block 82 with the formation of the optical stack 16 over the substrate 20. FIG. 6A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 6A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 6A-6E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 6B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 6E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 6C, the aperture formed in the sacrificial layer 25 can extend through the sacrificial layer 25, but not through the optical stack 16. For example, FIG. 6E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 6C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 6D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 6D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

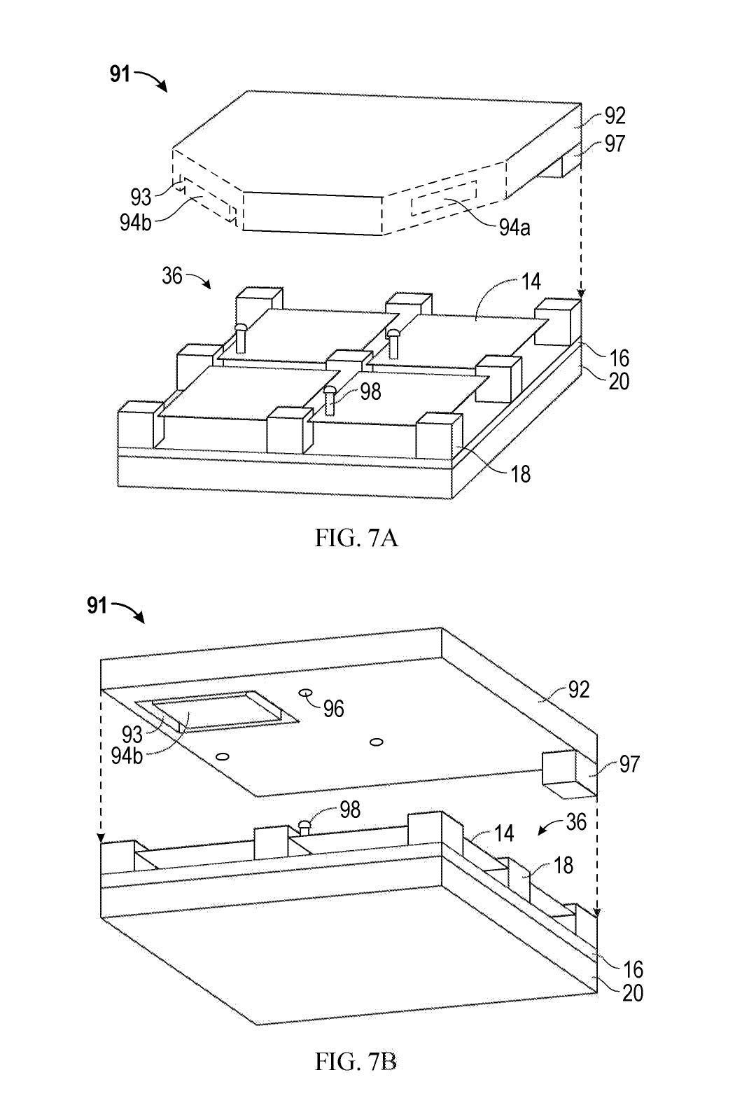

FIGS. 7A and 7B are schematic exploded partial perspective views of a portion of an EMS package 91 including an array 36 of EMS elements and a backplate 92. FIG. 7A is shown with two corners of the backplate 92 cut away to better illustrate certain portions of the backplate 92, while FIG. 7B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 7A and 7B, the backplate 92 can include one or more backplate components 94a and 94b, which can be partially or wholly embedded in the backplate 92. As can be seen in FIG. 7A, backplate component 94a is embedded in the backplate 92. As can be seen in FIGS. 7A and 7B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 7B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 7A and 7B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 7A and 7B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Various implementations of a multi-primary display device can include the EMS array 36. The EMS elements in the array can include one or more IMODs. In some implementations the IMOD can include an analog IMOD (AIMOD). The AIMOD may be configured to selectively reflect multiple primary colors and provide 1 bit per color.

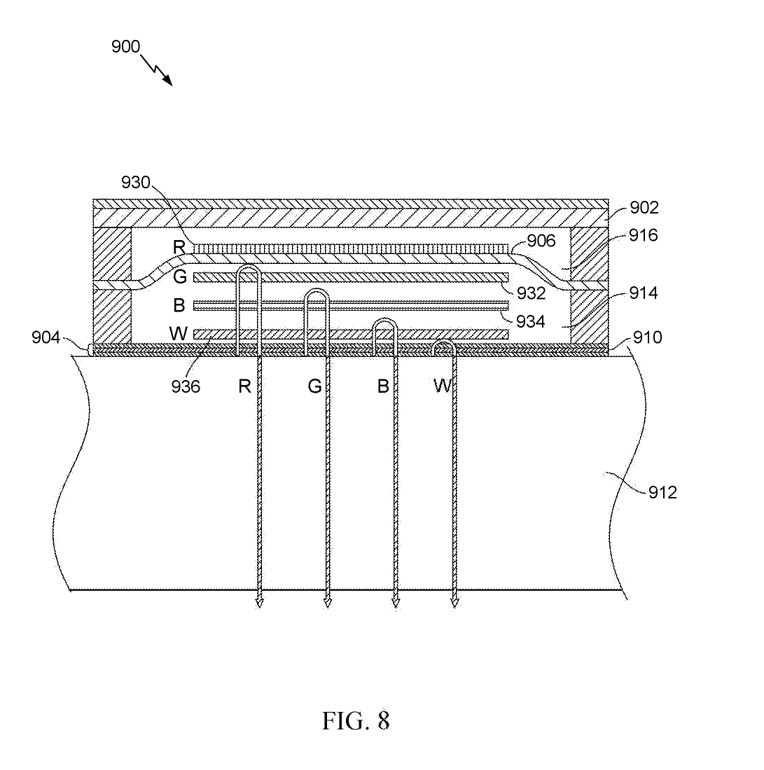

FIG. 8 shows a cross-section of an implementation of an AIMOD. The AIMOD 900 includes a substrate 912 and an optical stack 904 disposed over the substrate 912. The AIMOD includes a first electrode 910 and a second electrode 902 (as illustrated, the first electrode 910 is a lower electrode, and second electrode 902 is an upper electrode). The AIMOD 900 also includes a movable reflective layer 906 disposed between the first electrode 910 and the second electrode 902. In some implementations, the optical stack 904 includes an absorbing layer, and/or a plurality of other layers. In some implementations, and in the example illustrated in FIG. 8, the optical stack 904 includes the first electrode 910 which is configured as an absorbing layer. In such a configuration, the absorbing layer (first electrode 910) can be an approximately 6 nm layer of material that includes MoCr. In some implementations, the absorbing layer (that is, the first electrode 910) can be a layer of material including MoCr with a thickness ranging from approximately 2 nm to 50 nm.

The reflective layer 906 can be actuated toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 8 illustrates that the reflective layer 906 can be moved to various positions 930, 932, 934, and 936 between the first electrode 910 and the second electrode 902.

The AIMOD 900 in FIG. 8 has two structural cavities, a first cavity 914 between the reflective layer 906 and the optical stack 904, and a second cavity 916 between the reflective layer 906 and the second electrode 902. In various implementations, the first cavity 914 and/or the second cavity can include air. The color and/or intensity of light reflected by the AIMOD 900 is determined by the distance between the reflective layer 906 and the absorbing layer (first electrode 910).

The AIMOD 900 can be configured to selectively reflect certain wavelengths of light depending on the configuration of the AIMOD. The distance between the first electrode 910, which in this implementation acts as an absorbing layer and the reflective layer 906 changes the reflective properties of the AIMOD 900. Any particular wavelength is maximally reflected from the AIMOD 900 when the distance between the reflective layer 906 and the absorbing layer (first electrode 910) is such that the absorbing layer (first electrode 910) is located at the minimum light intensity of standing waves resulting from interference between incident light and light reflected from the reflective layer 906. For example, as illustrated, the AIMOD 900 is designed to be viewed from the substrate 912 side of the AIMOD (through the substrate 912), that is, light enters the AIMOD 900 through the substrate 912. Depending on the position of the reflective layer 906, different wavelengths of light are reflected back through the substrate 912, which gives the appearance of different colors. These different colors are also referred to as native or primary colors. The number of primary colors produced by the AIMOD 900 can be greater than 4. For example, the number of primary colors produced by the AIMOD 900 can be 5, 6, 8, 10, 16, 18, 33, etc.

A position of the movable layer 906 at a location such that it reflects a certain wavelength or wavelengths can be referred to as a display state of the AIMOD 900. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are substantially reflected such that and the AIMOD 900 appears “gray” or in some cases “silver,” and having low total reflection (or luminance) when a bare metal reflector is used. In some cases increased total reflection (or luminance) can be achieved with the addition of dielectric layers disposed on the metal reflector, but the reflected color may be tinted with blue, green or yellow, depending on the exact position of 936. In some implementations, in position 936, configured to produce a white state, the distance between the reflective layer 906 and the first electrode 910 is between about 0 and 20 nm. In other implementations, the AIMOD 900 can take on different states and selectively reflect other wavelengths of light based on the position of the reflective layer 906, and also based on materials that are used in construction of the AIMOD 900, particularly various layers in the optical stack 904.

The multiple primary colors displayed by a display element (for example, AIMOD 900) and the possible color combinations of the multiple primary colors displayed by a display element can represent a color space associated with the display element. A color in the color space associated with the display device can be identified by a color level that represents tone, grayscale, hue, chroma, saturation, brightness, lightness, luminance, correlated color temperature, dominant wavelength, or a coordinate in the color space associated with the display element.

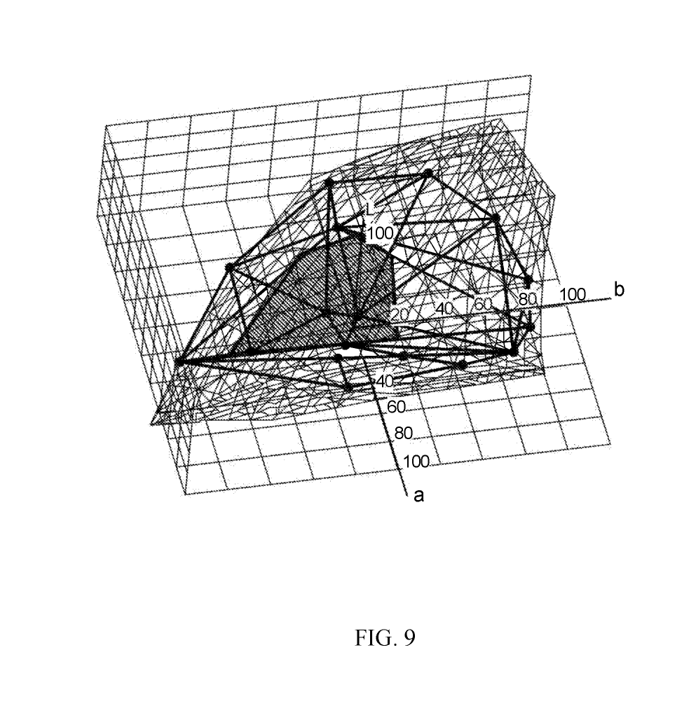

FIG. 9 illustrates an example of a color gamut produced by a multi-primary display device and the standard sRGB color gamut. The color gamut of an implementation of a multi-primary display device may have a polyhedron shape defined by N discrete primary colors produced by the display device and their linear combinations. In the color gamut shown in FIG. 9, sixteen (16) discrete primary colors are selected. Accordingly, N=16. In some implementations, the discrete primary colors can be selected from a spiral curve in the color space. By spatial and/or temporal mixing of these primaries, the human visual system receives a full spectrum of colors as a result of color blending. Any color located inside the polyhedron gamut can (at least theoretically) be obtained by color blending, as long as the spatial resolution and/or the temporal frame rate is sufficiently high. To choose appropriate primary combinations, the color image can be rendered in a vector manner, for example, to determine the appropriate output primary colors the input colors in the 3-dimensional (3D) color space can be investigated. Various implementations disclosed herein are directed towards selecting primary colors from a set including a large number of discrete primary colors (e.g., greater than four (4) or six (6)) to represent a color in a color space (for example, color space associated with a display device or a standard color space). The selected primary color vectors may be updated and stored in memory and/or registers for further processing including vector error diffusion. The vector error diffusion process involving primary color vectors is discussed in further detail below.

There are many methods for spatial and temporal color blending. One method to render images and/or videos on a display device includes error diffusion. Without subscribing to any particular theory, error diffusion includes halftoning methods in which a color difference (or an error) between the color of an incoming image pixel and the color of the corresponding display pixel to which the incoming image pixel is mapped is distributed to neighboring pixels. Without subscribing to any particular theory, error diffusion based approaches can render static images better than video images.

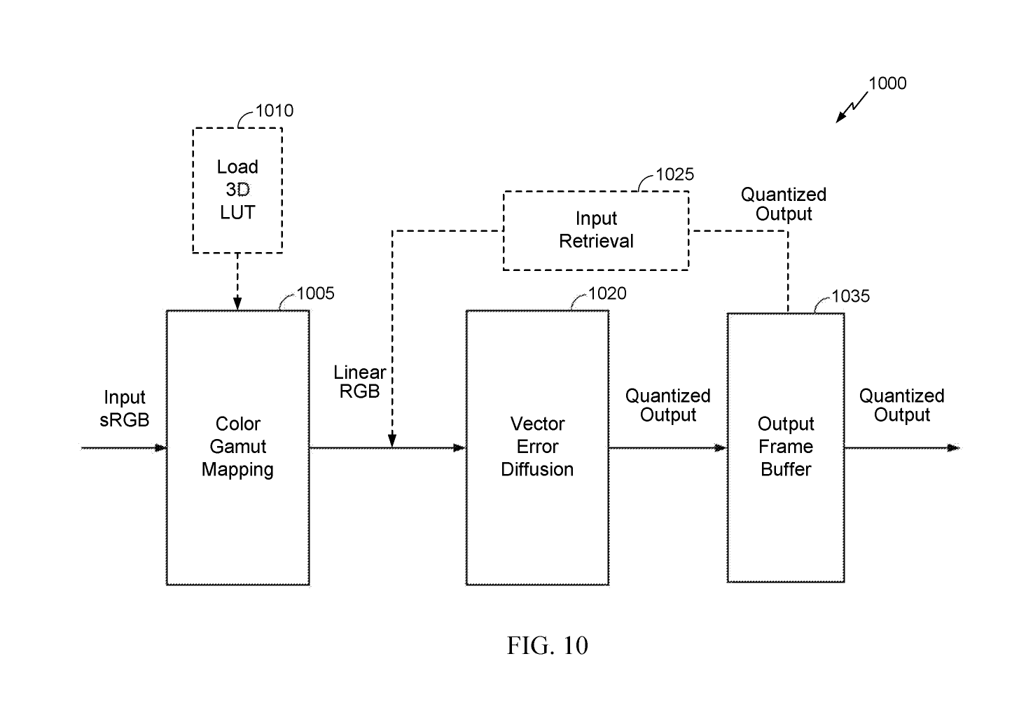

FIG. 10 is a functional block diagram that describes an implementation of a method 1000 of displaying an image on a multi-primary display device. Various implementations of the multi-primary display device can include an AIMOD 900. The various functional blocks illustrated in FIG. 10 can be implemented with processors executing instructions included in a machine-readable non-transitory storage medium, such as a RAM, ROM, EEPROM, etc. The various functional blocks can be implemented with electronic processors, micro-controllers, FPGA's, etc. The various functional blocks illustrated in FIG. 10 are described below.

The functional block 1005 is an optional color gamut mapping unit that is configured to receive an input image in a first color space and map it to a second color space. The second color space can be a color space associated with the display device. In various implementations, the first color space can be a sRGB color space and the second color space can be a linear RGB color space. In various implementations, the input image can be a 24-bit sRGB image and the image output from the color gamut mapping unit 1005 can be a 30-bit linear RGB image. The method may further include loading a look-up table (LUT) block 1010 that can be accessed by the color gamut mapping unit 1005 to map the input image from the first color space to the second color space. The LUT can include colors in the second color space that correspond to the colors in the first color space. In various implementations, the LUT can be a 3D LUT interpolation unit with M×M×M vertices. In implementations where the first color space is a sRGB color space and the second color space is a linear RGB color space, M can have a value of 9. The LUT can be re-loadable for different illumination environments. In various implementations, the LUT can be generated using an interpolation method such as, for example, tetrahedral interpolation method.

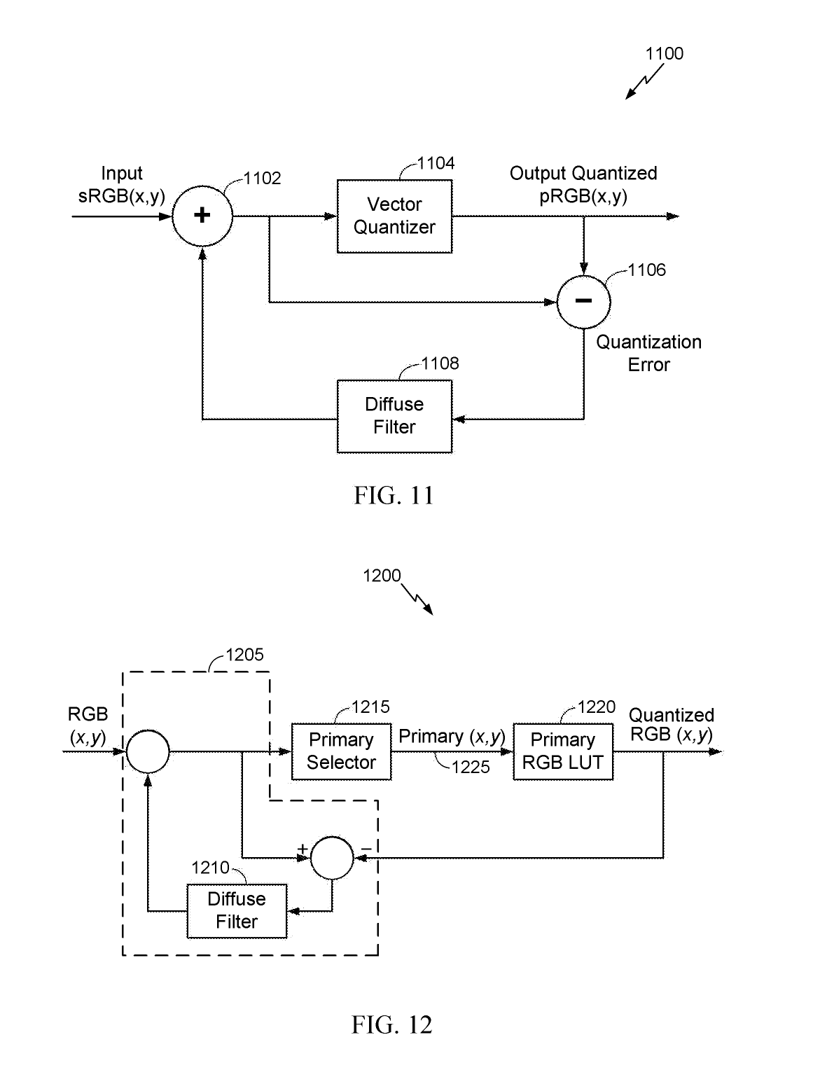

The vector error diffusion unit 1020 may provide power-saving advantage. Vector error diffusion based halftoning can provide over-all higher quality than the screening dithering method for static images. Vector error diffusion based halftoning can also be used for generating a quantized output image that can be saved in the output frame buffer 1035 for the always-on display (e.g., when the display module stops receiving video input from the host). In various implementations, the output of the vector error diffusion unit 1020 may be primary color indices or quantized RGB values. An implementation of an image processing method employed by the vector error diffusion unit 1020 is discussed below with reference to FIG. 11.

The output frame buffer 1035 is configured to store output from the vector error diffusion unit 1020 described above. In various implementations, only one frame is used for the output generated by the vector error diffusion unit 1020. Besides being used for the situation when the frame rate of the display device is higher than the frame rate of the input signal, the output frame buffer 1035 can also provide the input for the input image retrieval unit 1025 as described below. In various implementations having primary color indices as the quantized output, the size of the required output frame buffer can be 400×400×2×4 bits, where 4 bits are used for storing the primary index for each pixel in each frame, and 2 frames are used for a display device operating/running at 60 Hz. If the display device is operating/running at higher frame rate, the output buffer 1035 may contain more frames. For example, in various implementations, 3 frames may be used for a display device operating at 90 Hz frame rate and 4 frames may be used for a display device operating at 120 Hz frame rate.

The input image retrieval unit 1025 can be configured to translate the primary indices to RGB values in implementation having primary color indices as the quantized output and combine the two output frames to retrieve the original RGB input. The retrieved RGB input can be sent to the vector error diffusion unit 1020 to obtain a one-frame quantized output.

### 3D LUT Tetrahedral Interpolation

As discussed above, the optional color gamut mapping unit functional block 1005 can receive an input image in a first color space and map it to a second color space. The color gamut mapping unit 1005 can use a variety of methods to map the colors of an input image from a first color space to a second colors. For example, as discussed above, the colors of an input image can be mapped from a first color space to a second color using a tetrahedron interpolation method. The tetrahedron interpolation method can employ a three dimensional look-up table (LUT). In various implementations of the method 1000 illustrated in FIG. 10, the LUT can be a 3D LUT with 9×9×9 vertices. The input image can be a sRGB color image with unsigned 24 bits, and the output can be a linear RGB image including three colors with 30 bits. Therefore, the size of each table in the 3D LUT can have 9×9×9×30 bits.

### Vector Error Diffusion Based Halftoning

FIG. 11 is a block diagram of an implementation of vector error diffusion. As discussed above, vector error diffusion based halftoning can be used to render static and/or video images on a display device (for example, AIMOD 900). The method can be implemented using a programmable circuit or a processor (for example, vector error diffusion unit 1020). The input to the vector error diffusion system 1100 may be a linear RGB image or a sRGB image depending inclusion of the color gamut mapping discussed in connection with FIGS. 9-10. The input to the system 1100 may be added with a feedback output of a diffusion filter 1108 at a first adder 1102. A vector quantizer 1104 may receive an output of the first adder 1102, and the vector quantizer 1104 may generate a quantized RGB output. A second adder 1106 may receive the quantized RGB output and the output of the first adder 1102 to generate a quantization error, which is the difference between the quantized RGB output of the system 1100 and the output of the first adder 1102. The diffusion filter 1108 may receive the quantization error from the second adder 1106 to apply a weighted diffusion filter to the quantization error and to generate the feedback output to the next RGB image input to the system 1100.

FIG. 12 is a block diagram of another implementation of vector error diffusion. In this example the vector quantizer 1104 (shown in FIG. 11) is implemented as a primary selector 1215 and a primary RGB LUT 1225, and the adders and the diffusion filter 1210 may be substantially similar to corresponding units in FIG. 11. The primary selector 1215 may receive an output from a feedback loop 1205, which is the sum of the input RGB values to the vector error diffusion system 1200 and an output of the diffusion filter 1210. The primary selector 1215 may generate a primary color index 1225, which is a 4-bit one-channel image coded as primary indices for all pixels. The primary color index 1225 may be sent to the primary RGB LUT 1220, which may generate a quantized RGB value output of the system 1200.

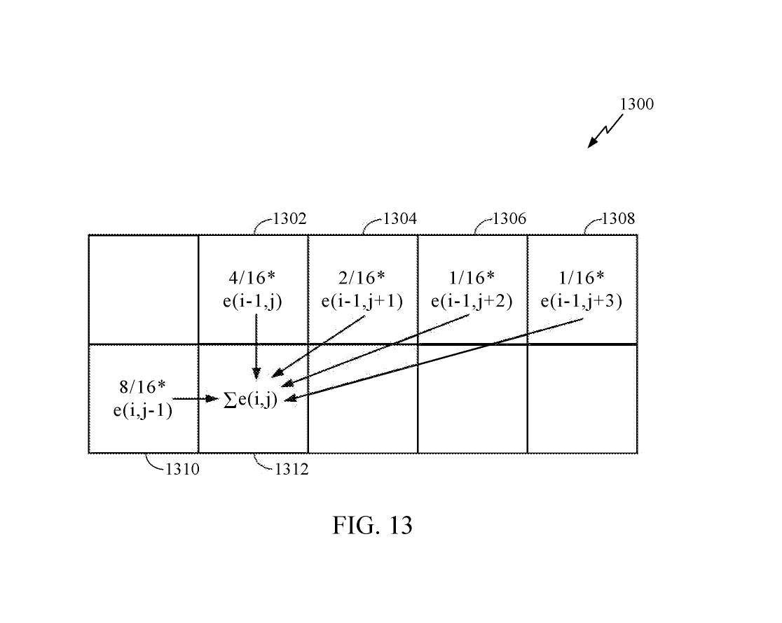

The input RGB values for each pixel may be modified by adding diffused errors from the feed-back loop 1205 that includes the diffusion filter 1210. The primary selector 1215 compares the desired color with N primaries to choose the output primary index 1225 to the closest color to the desired color. In various implementations, the closest color can be measured with respect to a distance in the color space. The selected primary index 1225 may be sent to the primary RGB LUT 1220 to generate quantized RGB value, which may be primary RGB values corresponding to the primary index 1225. The error or the difference between the selected primary RGB and the desired RGB color is calculated and sent to the feed-back loop 1205 with the diffusion filter 1210. The diffused errors are added to pixels at future processing locations, such as neighboring pixels of the current pixel, which may or may not be immediately adjacent to the current pixel. One example of an error diffusion filter is described in detail in connection with FIG. 13.

FIG. 13 illustrates an exemplary error diffusion filter operation in accordance with one implementation. A display portion 1300 shows a portion of a display screen having two rows and five columns of pixels. The exemplary diffusion filter in FIG. 13 is a five-tap filter having the five coefficients of 1/16, 1/16, 2/16, 4/16, and 8/16, whose sum is 1. The illustrated error diffusion filter is only an example, and a person having ordinary skill in the art would appreciate that the disclosure herein may be implemented using other filters, such as, for example, a four-tap Floyd-Steinberg filter having coefficients of 1/16, 3/16, 5/16, and 7/16, or any other similar diffusion filter. The number of taps and/or weight for each tap may be selected based on various considerations including but not limited to computation speed, power consumption, and ease of implementation. Furthermore, the direction of error propagation of the diffusion filter may be selected based on the order of pixel processing of the display (e.g., top to bottom, left to right) and a corresponding desired direction of pixel error dependency. The illustrated error diffusion filter, for example, may have a non-limiting advantage of fast and easy implementation because applying the filter, for example, multiplying errors by the diffusion coefficients as further described below, can be implemented with shift registers since the coefficients can be expressed in powers of 2.

In this example, an accumulated vector error for a pixel 1312 can be calculated by summing diffused quantization vector errors of pixels 1302, 1304, 1306, 1308, and 1310. Diffused quantization vector errors can be determined by applying the error diffusion filter to quantization vector errors, which involves multiplying the quantization vector errors by the coefficients of the diffusion error filter. For example, a quantization vector error e (i−1, j) of the pixel 1302 is multiplied by a coefficient of the error diffusion filter 4/16 as illustrated in FIG. 13. Similarly, quantization vector errors e (i−1, j+1) of the pixel 1304, e (i−1, j+2) of the pixel 1306, e (i−1, j+3) of the pixel 1308, and e (i, j−1) of the pixel 1310 are multiplied by coefficients of the error diffusion filter 2/16, 1/16, 1/16, and 8/16 respectively. These diffused quantization vector errors may be added to generate the accumulated vector error, Σe (i, j), of the pixel 1312.

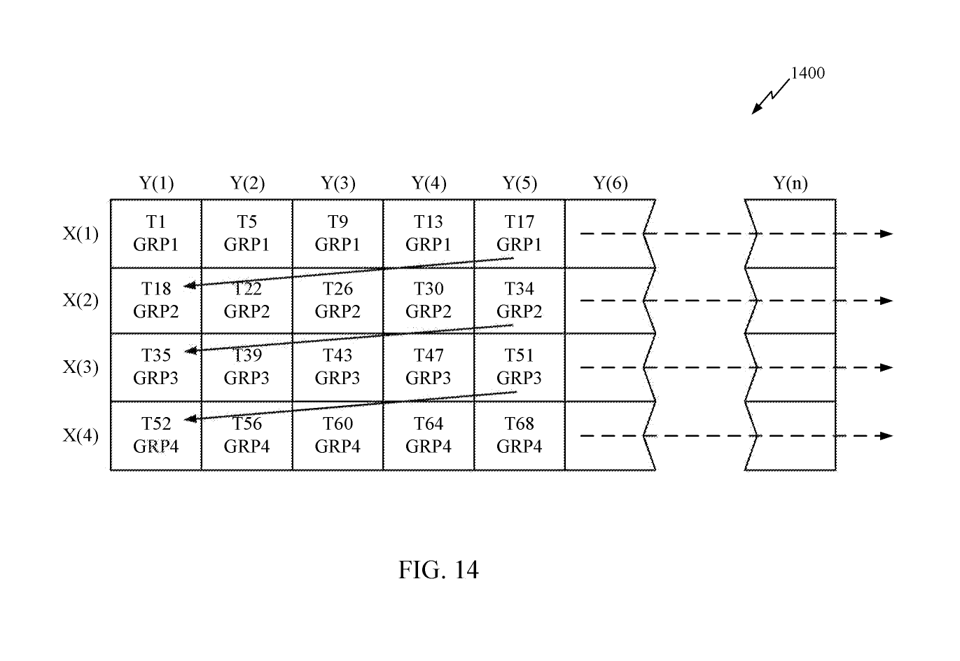

FIG. 14 illustrates error propagation and grouping and scheduling of pixels for processing in accordance with one implementation. A portion of a display 1400 in FIG. 14 includes four rows and n columns of pixels. As display devices often process pixels row by row, pixels on each of rows X(1), X(2), X(3), and X(4) can be grouped as Grp 1, Grp 2, Grp 3, and Grp 4 respectively as illustrated in FIG. 14. Also, as illustrated in FIG. 14, each pixel may have a timestamp assigned (e.g., T1, T5, etc.) that indicates order of processing. Scheduling of pixel processing may be based on the direction of residual error propagation according to the error diffusion filter and the direction of display frame buffer data generation. Timestamp assignment based on error diffusion filter dependency is described further below.

Vector error diffusion illustrated in FIG. 14 is implemented with a five-tap error diffusion filter such that an accumulated vector error at a pixel at (X(i), Y(j)) would be based on diffused quantization errors for example, weighted residual errors) from the pixels at (X(i−1), Y(j)), (X(i−1), Y(j+1)), (X(i−1), Y(j+2)), (X(i−1), Y(j+3)), and (X(i), Y(j−1)) similar to the exemplary error diffusion filter discussed in connection with FIG. 13. In this example, according to the direction of residual error propagation, from the row X(i−1) the accumulated vector error at the pixel at (X(i), Y(j)) only depends on the diffused quantization errors from the pixels at (X(i−1), Y(j)), (X(i−1), Y(j+1)), (X(i−1), Y(j+2)), and (X(i−1), Y(j+3)). Furthermore, for implementations with a typical frame buffer data generation, which processes pixels from top to bottom and left to right in a frame, the pixels on the left most column (e.g., Y(1) in FIG. 14) can be readily processed immediately after only a few diffused quantization errors from the previous row (e.g., residual errors from the pixels at (X(i−1), Y(1)), (X(i−1), Y(2)), (X(i−1), Y(3)), and (X(i−1), Y(4))) are processed since the left most pixels do not have a pixel on their left. For example, the accumulated vector error for the pixel at (X(2), Y(1)) can be determined after the diffused quantization vector errors of the pixels at (X(1), Y(1)), (X(1), Y(2)), (X(1), Y(3)), and (X(1), Y(4)) are determined and stored as illustrated by the top most arrow in FIG. 14.

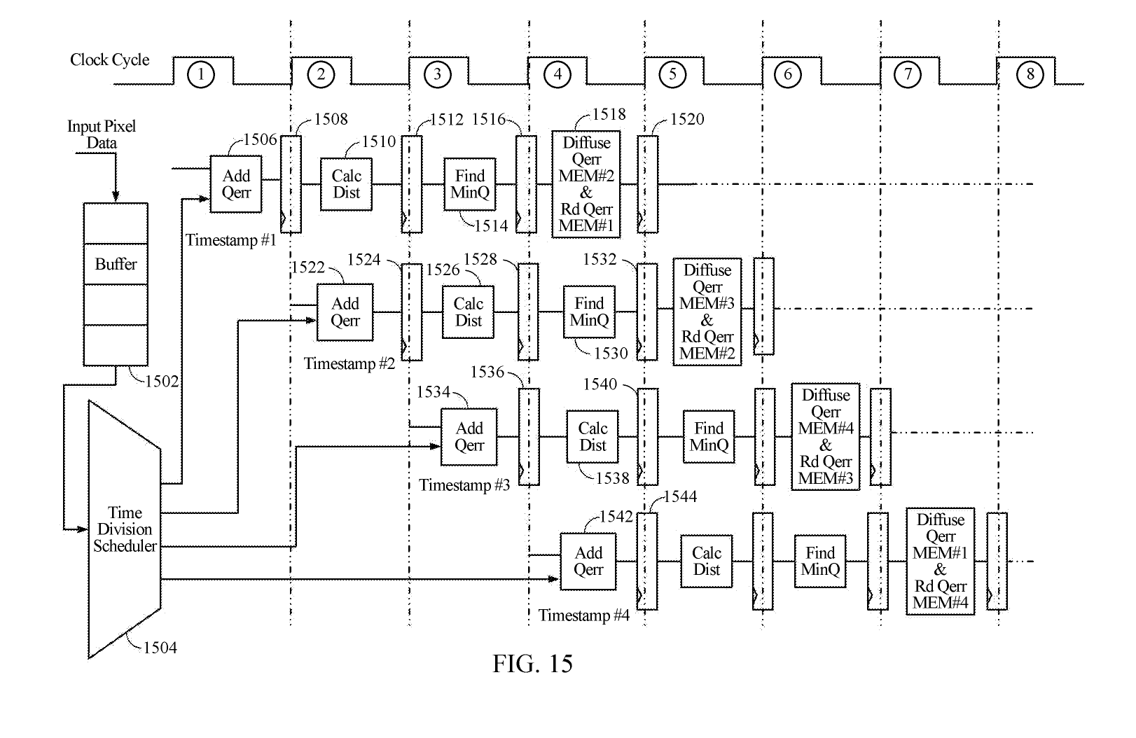

According to the accumulated error dependency discussed above, multiple pixels of a frame may be scheduled and assigned timestamps. In some implementations the error diffusion filter may be a tap-limited (for example, with a predetermined number of taps), causal (for example, linear time-invariant) finite impulse response (FIR) filter. Depending on the characteristics of the error diffusion filter, the accumulated vector error computation dependency may be determined a priori and, multiple pixel error processes can be scheduled to reduce the wait time, for example. In the example of FIG. 14, vector error processing for each pixel takes four pre-determined time intervals. Thus, the pixel at (X(1), Y(1)) is assigned the timestamp T1, and the pixel at (X(1), Y(2)) is assigned the time stamp T5, which is four pre-determined time intervals after T1. Similarly, the pixel at (X(1), (Y(3)) is assigned the timestamp T9, the pixel at (X(1), Y(4)) the timestamp T13, and the pixel at (X(1), Y(5)) the timestamp T17. In this example, at the entry of the timestamp T17, the diffused quantization vector error of the pixel (X(1), Y(4)) has been determined and stored; therefore, the processing of the pixel (X(2), Y(1)) may begin at the timestamp T18 before the entire processing of the pixel (X(1), Y(5)) is completed. The details of the processes performed in each time interval are described further below in connection with FIG. 15. The vector error diffusion scheduling discussed above is only an example implementation, and a person having ordinary skill in the art would appreciate that the scheduling above may be implemented differently depending in part on the characteristics of the error diffusion filter and/or display frame buffer data generation as long as the diffusion error dependencies are unaffected.

FIG. 15 is an exemplary multi-stage vector error diffusion pipeline in accordance with one implementation. The multi-stage vector error diffusion pipeline in FIG. 15 can be implemented as a virtual pipeline with one or more software modules and without having extra PLLs or dual- or multi-port RAM. The vector error diffusion pipeline can be implemented in a synchronous circuit having a predetermined clock cycle with pipeline registers in between two stages. The exemplary vector error diffusion pipeline has a buffer 1502 that receives input pixel data and sends the input pixel data to a time-division scheduler 1504. The exemplary vector error diffusion pipeline has four stages, 1506, 1510, 1514, and 1518. Processes performed in each stage may be organized so that the time to complete the processes in each stage can be roughly equal or comparable. The clock frequency may be chosen to allow the stage that takes the longest time to complete its processes within one clock cycle. The time interval discussed in connection with FIG. 14 can be one clock cycle in FIG. 15, and each clock cycle may be assigned a timestamp as illustrated in FIG. 15.

During the first stage 1506, an accumulated vector error (e.g., Σe (i, j) in FIG. 13) can be determined by loading previously stored diffused quantization vector errors (e.g., 4/16*e (i−1, j), 2/16*e (i−1, j+1), 1/16*e (i−1, j+2), 1/16*e (i−1, j+3), and 8/16*e (i, j−1) in FIG. 13). The time division scheduler 1504 sends pixel input data it received from the buffer 1502 to the module for the first stage 1506 and the pixel input data for pixel (i, j) (FIGS. 13-14) and the accumulated vector error can be added to generate a pre-quantization vector for pixel (i, j). Finally, quantization differences between the pre-quantization vector for pixel (i, j) and multiple predetermined color vectors, such as 16 primary color vectors, in the 3D color space. For example, if the pre-quantization vector for pixel (i, j) (FIGS. 13-14) is [xₚ yₚ zₚ] in the 3D color space, and the 16 primary color vectors are [x₁ y₁ z₁], [x₂ y₂ z₂], . . . , [x₁₆ y₁₆ z₁₆], the quantization differences may be 16 sets of differences such as |x₁−xₚ|, |x₂−xₚ|, . . . , |x₁₆−xₚ|. In some implementations the differences may not be determined in absolute values. In synchronous circuit implementations, the pre-quantization vector and the quantization differences calculated in the first stage 1506 may be saved in pipeline registers 1508.

During the second stage 1510, quantization distances can be calculated from the quantization differences determined at the first stage 1506. For example, quantization distances for pixel (i, j) can be 16 Euclidean distances between the pre-quantization vector for pixel (i, j) and 16 primary color vectors such as \sqrt{(x₁−xₚ)²+(y₁−yₚ)²+(z₁−zₚ)²}, \sqrt{(x₂−xₚ)²+(y₂−yₚ)²+(z₂−zₚ)²}, . . . , \sqrt{(x₁₆−xₚ)²+(y₁₆−yₚ)²+(z₁₆−zₚ)²}. In synchronous circuit implementations, the quantization distances calculated in the second stage 1510 may be saved in pipeline registers 1512. The pre-quantization vector from the first stage 1506 may also be saved in the pipeline registers 1512.

During the third stage 1514, a quantization vector error can be calculated based on one of the quantization distances from the second stage 1510. The quantization vector error may be determined by calculating the difference between the pre-quantization vector determined in the first stage 1506 and the quantization vector, which is the minimum distance among the quantization distances from the second stage 1510. The minimum distance among the quantization distances may be determined in a variety of ways. For example, the quantization distances may be sorted based on their magnitudes through a sorting function, and the minimum distance may be selected after the sorting operation. In some implementations, the quantization distances may be referred to by their index numbers and the index number for the minimum distance may be determined and selected instead of the minimum distance value itself. Referencing the quantization distances by their index numbers may have a non-limiting advantage of ease of retrieving a corresponding reference vector (e.g., one of the 16 primary color vectors) based on the index number of the minimum distance. Based on the minimum distance, a corresponding reference vector (e.g., one of the 16 primary color vectors) may be retrieved and selected as a quantization vector. The quantization vector error may be determined by calculating the difference between the quantization vector and the pre-quantization vector. In synchronous circuit implementations, the quantization vector error calculated in the third stage 1514 may be saved in pipeline registers 1516.

During the fourth stage 1518, a diffused quantization vector error can be calculated by applying an error diffusion filter to the quantization vector error from the third stage 1514. The error diffusion filter may be substantially similar to the filters described in connection with FIG. 13 above. Applying an error diffusion filter may involve multiplying the coefficients of the error diffusion filter, each of which may be less than 1 and the sum of which may be 1, to the quantization vector error from the third stage 1514. The multiplication of the coefficients and the quantization vector error may be performed in a variety of ways partly depending on the value of the coefficients. For example, if the filter coefficients are chosen such that they are powers of 2, the multiplication process may be implemented with shift registers. As discussed in connection with FIG. 13, an error diffusion filter with taps 1/16, 1/16, 2/16, 4/16, and 8/16 may be implemented with shift registers since the coefficients may be expressed in powers of 2. Implementing multiplication with shift registers may benefit from decreased time of operation and power consumption. In some implementations, multiple registers may be configured to receive and store a quantization vector error only once and shift the quantization vector error generate one or more diffused quantization vector errors over one or more clock cycles. In some implementations, multiple registers may be configured to interleave or combine the shifting and adding of multiple quantization vector errors over one or more clock cycles after saving each quantization vector error only once in the registers. The diffused quantization vector error calculated in the fourth stage 1518 may be added to the previously calculated one or more diffused quantization vector errors and may be stored in memory for later processes in the pipeline. In some implementations, a diffused quantization vector error or summed diffused quantization vector errors for a following stage may be read from memory to pipeline registers 1520, for example. Implementations utilizing registers and minimizing reading and writing from memory may reduce time and power consumption.

The stages 1506, 1510, 1514, and 1518 described above can be pipelined as illustrated in FIG. 15. For example, as the process for pixel (i, j) (FIGS. 13-14) enters the second stage 1510, the process for pixel (i+1, j−4) may enter its first stage 1522. Similarly, as the process for pixel (i, j) enters the third stage 1514, the process for pixel (i+1, j−4) may enter its second stage 1526, and the process for pixel (i+2, j−8) may enter its first stage 1534. As the process for pixel (i, j) enters the fourth stage 1518, the process for pixel (i+1, j−4) may enter its third stage 1530, and the process for pixel (i+2, j−8) may enter its second stage 1538, and the process for pixel (i+3, j−12) may enter its first stage 1542. The pipelined processes described above may continue until the processes for all the pixels are entered into the pipeline and processed accordingly.

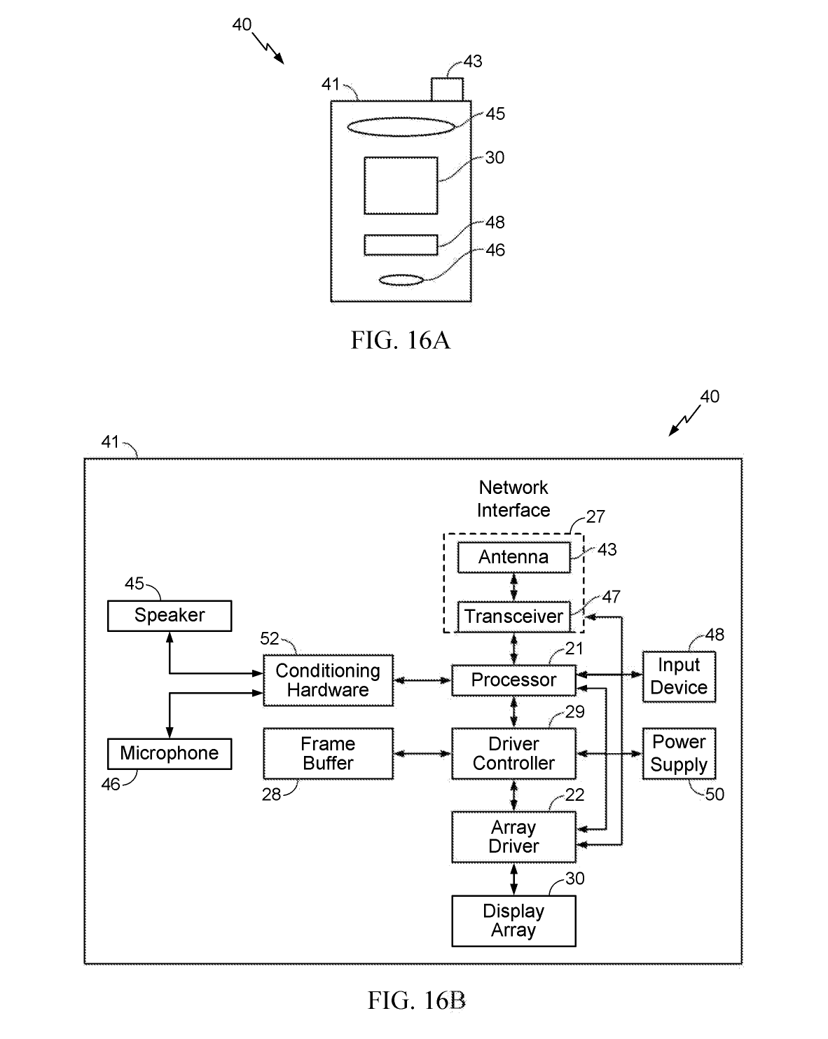

FIGS. 16A and 16B are system block diagrams illustrating a display device 40 that includes a plurality of IMOD display elements including but not limited to implementations similar to AIMOD 900. The display device 40 can be configured to use temporal (and/or spatial) modulations schemes that utilize the constrained color palette disclosed herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 16A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 16A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level. The processor 21 (or other computing hardware in the device 40) can be programmed to perform implementations of the methods described herein. The processor 21 (or other computing hardware in the device 40) can be in communication with a computer-readable medium that includes instructions, that when executed by the processor 21, cause the processor 21 to perform implementations of the methods described herein.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). The driver controller 29 and/or the array driver 22 can be an AIMOD controller or driver. In some implementations, the driver controller 29 can be integrated with the array driver 22. Such an implementation can be useful in highly integrated systems, for example, mobile phones, portable-electronic devices, watches, or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described methods for generating a constrained color palette may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray Disc™ where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method of diffusing vector error by processing, in a virtual pipeline with a plurality of stages, error data of each of a plurality of pixels, that together form an image, the method comprising:
retrieving from a memory component a plurality of diffused quantization vector errors;
determining an accumulated vector error based on the plurality of diffused quantization vector errors;
determining a pre-quantization vector by adding the accumulated vector error to an input vector;
determining a plurality of quantization differences based on the pre-quantization vector and a plurality of reference vectors;
determining a plurality of quantization distances based on the plurality of quantization differences;
determining a quantization vector error based on one of the plurality of quantization distances;
applying an error diffusion filter at least to the quantization vector error to generate at least another diffused quantization vector error; and
storing the another diffused quantization vector error.

2. The method of claim 1, wherein the plurality of quantization distances are Euclidean distances between the pre-quantization vector and the plurality of reference vectors.

3. The method of claim 1, wherein the determining the quantization vector error comprises:
selecting a minimum distance from the plurality of quantization distances as a quantization vector; and
determining a difference between the quantization vector and the pre-quantization vector.

4. The method of claim 3, wherein the selecting the minimum distance from the plurality of quantization distances comprises:
sorting the plurality of quantization distances; and
selecting an index of the minimum distance from the plurality of quantization distances.

5. The method of claim 1, wherein the applying the error diffusion filter at least to the quantization vector error comprises multiplying a coefficient less than one to the quantization vector error by shifting the quantization vector error.

6. The method of claim 1, wherein the storing the another diffused quantization vector error comprises storing the another diffused quantization vector error in a register.

7. The method of claim 1, wherein the plurality of reference vectors include at least 16 primary color vectors.

8. The method of claim 1, wherein the error diffusion filter is a tap-limited causal finite impulse response (FIR) filter kernel.

9. An apparatus for diffusing vector error, comprising:
a processor coupled to a memory component and configured to implement a virtual pipeline to process error data of a plurality of pixels, that together from an image, the processor further configured to process error data of each of a plurality of pixels by
retrieving from the memory component a plurality of stored diffused quantization vector errors,
determining an accumulated vector error based on the plurality of stored diffused quantization vector errors,
receiving pixel input data for a pixel from the buffer,
determining a pre-quantization vector by adding the accumulated vector error to the pixel input data,
determining a plurality of quantization differences based on the pre-quantization vector and a plurality of reference vectors,
determining a plurality of quantization distances based on the plurality of quantization differences,
determining a quantization vector error based on one of the plurality of quantization distances,
applying an error diffusion filter at least to the quantization vector error to generate at least another diffused quantization vector error, and
storing the at least another diffused quantization vector error.

10. The apparatus of claim 9, wherein the memory component is configured to store the another diffused quantization vector error for at least one of the plurality of pixels.

11. The apparatus of claim 9, wherein the processor is further configured to process the error data of each of the plurality of pixels further by
selecting the minimum distance from the plurality of quantization distances as a quantization vector; and
determining a difference between the quantization vector and the pre-quantization vector.

12. The apparatus of claim 11, wherein the processor is further configured to process the error data of each of the plurality of pixels further by
sorting the plurality of quantization distances; and
selecting an index of the minimum distance from the plurality of quantization distances.

13. The apparatus of claim 11, further comprising a display device configured to output pixel data based on the quantization vector.

14. The apparatus of claim 13, wherein the display device further comprises:
a driver controller configured to receive instructions to display the pixel data; and
a display array comprising a plurality of analog interferometric modulators (AIMODs).

15. The apparatus of claim 9, wherein the plurality of quantization distances are Euclidean distances between the pre-quantization vector and the plurality of reference vectors.

16. The apparatus of claim 9, wherein the applying an error diffusion filter at least to the quantization vector error comprises multiplying a coefficient less than one to the quantization vector error by shifting the quantization vector error.

17. The apparatus of claim 9, wherein the processor is further configured to process the error data of each of the plurality of pixels further by storing the another diffused quantization vector error in a register.

18. The apparatus of claim 9, wherein the plurality of reference vectors include at least 16 primary color vectors.

19. The apparatus of claim 9, wherein the error diffusion filter is a tap-limited causal finite impulse response (FIR) filter kernel.

20. The apparatus of claim 9, further comprising:
a display; and
a processor that is configured to communicate with the display, the processor being configured to process image data.

21. The apparatus as recited in claim 20, further comprising a driver circuit configured to send at least one signal to the display.

22. The apparatus as recited in claim 21, further comprising a controller configured to send at least a portion of the image data to the driver circuit.

23. The apparatus as recited in claim 20, further comprising an image source module configured to send the image data to the processor.

24. The apparatus as recited in claim 23, wherein the image source module includes at least one of a receiver, transceiver, and transmitter.

25. The apparatus as recited in claim 20, further comprising an input device configured to receive input data and to communicate the input data to the processor.

26. A non-transitory computer-readable medium storing instructions that, when executed, causes at least one physical computer processor to perform a method of diffusing vector error by processing error data of each of a plurality of pixels, that together form an image, processing of the error data of the plurality of pixels being in a virtual pipeline with a plurality of stages, the method comprising:
retrieving from a memory component a plurality of diffused quantization vector errors;
determining an accumulated vector error based on the plurality of stored diffused quantization vector errors;
determining a pre-quantization vector by adding the accumulated vector error to an input vector;
determining a plurality of quantization differences based on the pre-quantization vector and a plurality of reference vectors;
determining a plurality of quantization distances based on the plurality of quantization differences;
determining a quantization vector error based on one of the plurality of quantization distances;
applying an error diffusion filter at least to the quantization vector error to generate at least another diffused quantization vector error; and
storing the another diffused quantization vector error.

27. The computer-readable medium of claim 26, wherein the plurality of quantization distances are Euclidean distances between the pre-quantization vector and the plurality of reference vectors.

28. The computer-readable medium of claim 26, wherein the plurality of reference vectors include at least 16 primary color vectors.

29. The computer-readable medium of claim 26, wherein the error diffusion filter is a tap-limited causal finite impulse response (FIR) filter kernel.
